(19) United States
(12) Patent Application Publication
(10) Pub. No.: US 2014/0358968 A1
(43) Pub. Date: Dec. 4, 2014

(54) METHOD AND SYSTEM FOR SEAMLESS QUERYING ACROSS SMALL AND BIG DATA REPOSITORIES TO SPEED AND SIMPLIFY TIME SERIES DATA ACCESS

(71) Applicant: GE Intelligent Platforms, Inc., Charlottesville, VA (US)

(72) Inventors: Ward Bowman, Foxboro, MA (US); Kareem Sherif Aggour, Niskayuna, NY (US); Eric Thomas Pool, Roswell, GA (US); Michael J. Solda, Norway, MI (US); Sunil Mathur, East Walpole, MA (US); Jerry Lin, Seattle, WA (US); Brian Courtney, Naperville, IL (US)

(21) Appl. No.: 13/909,566

(22) Filed: Jun. 4, 2013

(51) Int. Cl. G06F 17/30

(52) U.S. Cl. CPC G06F 17/30675
USPC 707/771

(57) ABSTRACT

Included herein is a method for providing seamless access to time series data located in multiple time series data storage units. A user makes a data query without knowing where the data is stored or in what format. The data request is received and parsed by a query interface and the data interface formulates one or more data requests for the specific time series data storage device where the queried data are stored. The time series data received from the data storage device is assembled by the query interface and displayed to the user.

### FIELD OF THE INVENTION

The present invention generally relates to database access, and more specifically to a method for abstracting database access.

### BACKGROUND OF THE INVENTION

Large amounts of information become available as a consequence of the collection and analysis of more and more time series data. As newer data are collected, the older data are typically moved to larger and less frequently accessed storage units. Generally, the older time series data builds up over time and becomes quite large and are often referred to as Big Data with the larger storage unit referred to as a Big Data repository. The newer time series data generally remains relatively small and can be referred to as Small Data stored in a Small Data repository. The distinction in the age of the data between the Big Data and the Small Data leads to different usage characteristics. For example, the distinction typically impacts the data's frequency of use. That is, the more recent Small Data is typically accessed and used more frequently than the older Big Data.

Many applications require Big Data repositories for storing and mining massive quantities of historical time series data. As Big Data technologies become more prevalent, increasing numbers of applications will require combinations of both big and small data repositories functioning in tandem—using the small data repositories to store the most frequently accessed, such as recently added or updated, data points. This is because Big Data repositories are very effective at enabling deep analytics on large volumes of data, but the analytics typically execute in batch and thus do not provide real or near real-time access to the data.

However, combining big data and small data repositories within a single infrastructure presents a challenge when a user desires to execute queries and/or analytics. Traditionally, as shown in FIG. 1, a user 102 would have to know in advance which repository the time series data resides within, in order to direct their queries or analytics to the proper destination. For example, the user 102 will need to know if the data resides in a device 106 or a device 108 before entering a query at a computing device 104. Similarly, the query or analytic itself would be structured very differently dependent upon whether it's running in the small data environment vs. the big data infrastructure, since the time series data would most likely be stored very differently from one environment to the next.

Therefore, there is a need for a system and method that provide a single data access interface regardless of where the time series data are stored and it is to this need that embodiments of the present invention are primarily directed.

### SUMMARY OF THE EMBODIMENTS OF THE INVENTION

Embodiments of the present invention are constructed to overcome the aforementioned deficiencies. The embodiments provide a single data access method for time series data stored in different location or under different data structure.

The embodiments also provide a method for providing seamless access to time series data located in multiple data storage units. The method includes receiving a first data request for a data from a user device, parsing, by a query interface controller, the first data request identifying a location of the data. The method also includes formulating, by the query interface controller, at least one second data request, sending the at least one second data request to at least one data storage unit. The time series data are received from the at least one data storage unit, and are sent to the user device.

Another illustrious embodiment provides an apparatus for providing seamless access to time series data located in multiple data storage units. The apparatus includes a user interface controller for receiving a first data request from a user device, a query interface controller for parsing the first data request and identifying multiple data storage units. The query interface controller is capable of formulating an appropriate data request for each of the multiple data storage units. The apparatus also includes an input/output (I/O) controller for sending the data requests to the data storage units and receiving data from each data storage unit. The query interface controller then combines the multiple query results and finally, the user interface controller sends the complete time series data to the user device.

The foregoing and other objects, features, aspects and advantages of the present invention will become better understood from a careful reading of a detailed description provided herein below with appropriate reference to the accompanying drawings.

### BRIEF DESCRIPTION OF THE DRAWINGS

The present invention can be understood in more detail by reading the subsequent detailed description in conjunction with the examples and references made to the accompanying drawings, wherein:

FIG. 1 is an illustration 100 of a data access according to the prior art;

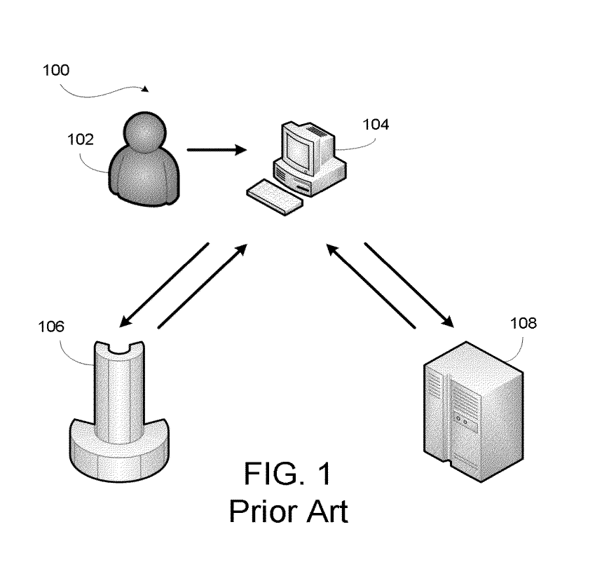

FIG. 2 is a schematic view 200 of time series data access according to the present invention;

FIG. 3 is a flowchart 300 of an exemplary time series data access method according to an embodiment of the present invention; and

FIG. 4 is a block diagram of a device for providing data access of the present invention.

### DETAILED DESCRIPTION OF THE PREFERRED EMBODIMENTS

Embodiments of the present invention provide a capability that abstracts the details of the underlying data stores away from the end user, as to eliminate the need for the user to know the format in which the data is to be stored. The embodiments utilize a common interface that is positioned atop of data repositories and is capable of receiving queries, parsing them to determine their data requirements, executing the queries against the appropriate repository or repositories, and combining any results that straddle the small and big time series data stores.

Aspects of the illustrious embodiments work by building a query interface layer that can sit atop different data stores. This layer receives queries, parses them to determine what repositories are most likely to hold the relevant data, and then executes the queries against the relevant data stores. The layer joins (if run against more than one data store) and returns any results. The query interface controller embodiments use metadata about each repository that defines the structure and attributes of the time series data stored in each repository, in order to determine which repository or repositories hold the data being requested by the user.

The query interface layer uses this metadata to become aware of what data is available and in which repository they may be stored. When the query layer parses a query, it can use the parameters of the query to determine what repository, or repositories, house the time series data being requested. For example, if a query requests daily averages of an indicator over the prior three weeks and the query interface layer knows that the small data repository houses the indicator data created over the last month, the actual query can be executed in the small data repository alone.

Alternatively, if the query requests daily averages of the indicator over the past two months, the query interface layer would know to pull the most recent month from the small data repository and the prior month from the big data repository. The results would then be combined in the query interface layer before finally being returned to the requester.

The embodiments of the present invention address the challenge of using multiple time series data repositories to address different data challenges a single system faces. Both small and big data repositories may be required within one infrastructure, to serve very different purposes. Small data repositories give very fast access to limited amounts of data. Big Data repositories allow users to store hundreds of terabytes of data or more, but provide only batch analytic execution on that data. If multiple such data repositories are used within a single system, a significant challenge arises with respect to how end users (and other systems) will interact with those multiple repositories.

Users who wish to analyze the stored data conventionally need special insights into the data repositories to know what time series data is stored where. Embodiments of the present invention solve that problem by creating a layer that sits atop the many repositories to provide an interface to receive and parse queries, distribute the queries to the right repositories, and then combine the results where the queries cross from the small and into the big data stores.

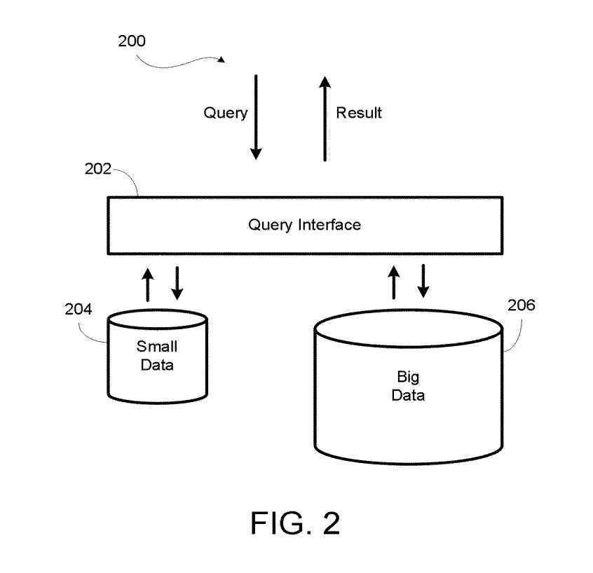

FIG. 2 is a schematic view 200 of time series data access according to embodiments of the present invention. The query formulated by a user is first received and interpreted by a query interface 202. The query interface 202 translates the query from the user into a specific query for either Small Data 204 or Big Data 206. The query interface 202 parses the query and identifies the time series data location. The query interface 202 will then formulate a new query for the specific data location. If the data reside in more than one location, the query interface 202 will formulate multiple queries to be sent to multiple data storage units.

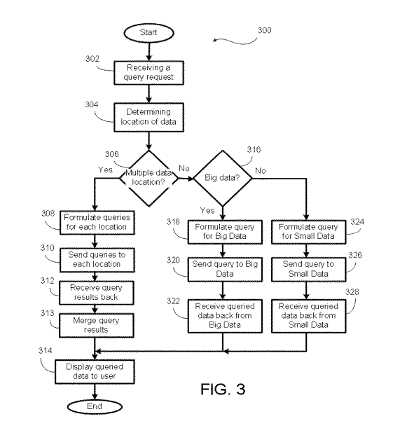

FIG. 3 is a flowchart 300 for seamless querying according to an exemplary method of embodiments of the present invention. After a data query request is received from a user device, step 302, the query interface 202 parses the query and determines the location of the data (storage unit), step 304. The data storage unit is often determined according to subject matter of the data requested. The time series data location information may be retrieved from a data storage unit.

The query interface 202 checks if the data resides in more than one data location, step 306. If the time series data is spread in more than one location, the query interface 202 formulate multiple queries, one for each data storage unit, step 308, and sends queries to different data storage units, step 310. The query interface 202 receives query results back from each data storage unit, step 312, merges the query results, step 313, and then assembles and displays or forwards the queried data to the user, step 314. Because the queries are sent to multiple time series data storage units, the responses from these storage units may not arrive simultaneously. The data interface 202 may send or forward partial results to the user before all the results are received.

If the desired data are not spread in multiple locations, the query interface 202 checks if the data are Big Data, step 316. If the data are Big Data, the query interface 202 formulates the query for the Big Data storage unit, step 318, and sends the query to the Big Data storage unit, step 320. After the queried data is received back from Big Data, step 322, the query interface 202 proceeds to display or forward the data to the user, step 314.

If the desired data are not spread in multiple locations and are not Big Data, the query interface 202 formulates the query for the Small Data storage unit, step 324, and sends the query to the Small Data storage unit, step 326. After the queried data is received back from the Small Data storage unit, step 328, the query interface 202 proceeds to display or forward the time series data to the user, step 314.

Although FIG. 3 is an illustration of a process for a seamless querying for time series data residing in two different storage units, one skilled in the art would understand that the method described in FIG. 3 can be easily adapted for querying time series data located in multiple locations. The method can also be adapted to access the data that are spread according to criteria other than time. For example, if a user wants to access annual real estate tax information over some time window for a particular land parcel located in California. The user need not know geographical location, e.g. which county, the land parcel is located and the query interface will identify the land parcel and the county where the land parcel is located. After identifying the county where the land parcel is located, the query interface manager formulates the query according to the requirements for the server for that particular county and sends the query to the appropriate server.

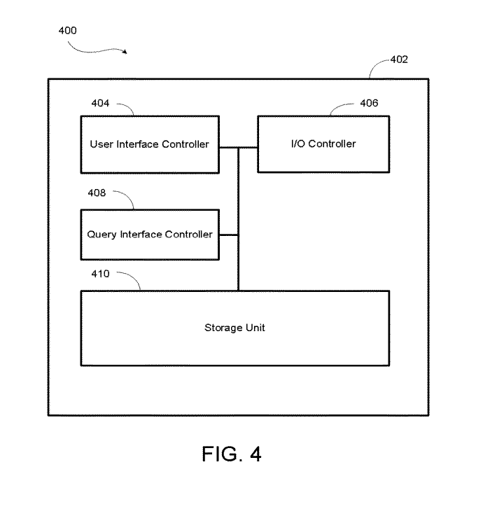

FIG. 4 is a block diagram 400 of a device 402 for supporting seamless querying of the present invention. The device 402 has a user interface controller 404, an input/output (I/O) controller 406, a query interface controller 408, and a storage unit 410. The user interface controller 404 receives data queries from users and the query interface controller 408 parses the data queries and identifies the location of the data requested by the users. The query interface controller 408 also formulates queries directed to each data location.

The I/O controller 406 sends the newly formulated queries to each time series data location and receives the data back from each data location. When the data are received from multiple data storage units, the data that are received first can be stored in the storage unit 410 until all the data are received. After all the time series data are received, the query interface controller unit 408 assembles all the received data and the user interface controller unit 404 presents them to the user. The information on the data location can also be saved in the storage unit 410.

Embodiments of the present invention provide a major level of simplification for users who are required to interface with such systems. Prior to the present invention, users would be required to develop multiple distinct paths to integrate with each repository, and know a priori what data is found in each. The benefits of the present invention eliminates a significant level of complexity to anyone needing to build or interact with a system that requires different tiers of time series data storage. From a commercial perspective, the embodiments greatly simplify the deployment of systems that include multiple time series data repositories. Such a feature provides significant commercial sales advantage over any competitive systems.

Although the present invention has been described with reference to the preferred embodiments, it will be understood that the invention is not limited to the details described thereof. Various substitutions and modifications have been suggested in the foregoing description, and others will occur to those of ordinary skill in the art. For example, the data may be stored in more than two different locations. Therefore, all such substitutions and modifications are intended to be embraced within the scope of the invention as defined in the appended claims. It is understood that features shown in different figures can be easily combined within the scope of the invention.

What is claimed is:

1. A method for providing seamless access to time series data located in multiple data storage units, comprising:
receiving a first data request for time series data from a user device;
parsing, by a query interface controller, the first data request;
identifying a location of the data;
formulating, by the query interface controller, at least one second data request;
sending the at least one second data request to at least one time series data storage unit;
receiving the data from the at least one data storage unit; and
sending the data to the user device.

2. The method of claim 1 further comprising retrieving the data location information from at least one of the time series data storage units.

3. The method of claim 1, wherein the at least one second data request includes two different time series data requests.

4. The method of claim 1, wherein the identifying a location of the data further comprises identifying a data storage unit according to the data requested by the user.

5. The method of claim 4, wherein the data storage unit relates to time of creation of subject matter of the data.

6. The method of claim 4, wherein the data storage unit relates to geographical location of subject matter of the time series data.

7. An apparatus for providing seamless access to data located in multiple time series data storage units, comprising:
a user interface controller for receiving a first data request from a user device;
a query interface controller for parsing the first data request and identifying a time series data storage unit, the query interface controller being capable of formulating a second data request; and
an input/output (I/O) controller for sending the second data request to the time series data storage unit and receiving data from the time series data storage unit,
wherein the user interface controller sends the data to the user device.

8. The apparatus of claim 7, wherein the query interface controller is configured to retrieve the data location information from a storage unit.

9. The apparatus of claim 7, wherein the query interface controller formulates two different data requests for the second data request.

10. The apparatus of claim 7, wherein the query interface controller identifies a time series data storage unit according to the data requested by the user.

11. The apparatus of claim 10, wherein the query interface controller identifies time of creation of subject matter of the data.

12. The apparatus of claim 10, wherein the query interface controller identifies geographical location of subject matter of the time series data.
